(19) United States
(12) Patent Application Publication
(10) Pub. No.: US 2024/0334262 A1
(43) Pub. Date: Oct. 3, 2024

(54) INTERWORKING BETWEEN LAYER 3 (L3) HANDOVER AND LAYER 1 (L1)/LAYER 2 (L2) CENTRIC INTER-CELL CHANGE

(71) Applicant: Nokia Technologies Oy, Espoo (FI)

(72) Inventors: Subramanya CHANDRASHEKAR, Bangalore (IN); Tero HENTTONEN, Espoo (FI); Halit Murat GÜRSU, Munich (DE)

(21) Appl. No.: 18/578,599

(22) PCT Filed: Jun. 23, 2022
(86) PCT No.: PCT/EP2022/067147

§ 371 Date: Jan. 11, 2024

(30) Foreign Application Priority Data
Jul. 12, 2021 (IN) 202141031190

(51) Int. Cl. H04W 36/00; H04L 5/00; H04W 36/04

(52) U.S. Cl. CPC H04W 36/0058; H04L 5/0053; H04W 36/0016; H04W 36/04

(57) ABSTRACT

Systems, methods, apparatuses, and computer program products for managing or controlling L1/L2 centric mobility and L3 mobility are provided. One method may include receiving, at distributed unit (DU) of a network node, a message from a centralized unit (CU) of the network node. The message may include a flag to indicate that a L3 handover of a user equipment (UE) is being prepared or executed. Based on at least one of the received message and a measurement report received from the user equipment (UE), determining, by the distributed unit (DU), whether the user equipment (UE) should perform a L1/L2 inter-cell change or the L3 handover.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for managing or controlling layer 1 (L1)/layer 2 (L2) centric mobility and layer 3 (L3) mobility.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to a method that may include receiving, at distributed unit of a network node, a message from a centralized unit of the network node. The message comprises a flag to indicate that a layer 3 handover of a user equipment is being prepared or executed. Based on at least one of the said received message and a measurement report received from the user equipment, the method may include determining, by the distributed unit, whether the user equipment should perform a layer 1/layer 2 inter-cell change or the layer 3 handover.

Another embodiment may be directed to an apparatus, which may include at least one processor and at least one memory comprising computer program code. The at least one memory and computer program code configured, with the at least one processor, to cause the apparatus at least to perform: receiving, at distributed unit, a message from a centralized unit. The message comprises a flag to indicate that a layer 3 handover of a user equipment is being prepared or executed. Based on at least one of the said received message and a measurement report received from the user equipment, the apparatus may be caused to perform determining, by the distributed unit, whether the user equipment should perform a layer 1/layer 2 inter-cell change or the layer 3 handover.

Another embodiment may be directed to an apparatus including means for receiving, at distributed unit, a message from a centralized unit. The message comprises a flag to indicate that a layer 3 handover of a user equipment is being prepared or executed. Based on at least one of the said received message and a measurement report received from the user equipment, the apparatus may include means for determining, by the distributed unit, whether the user equipment should perform a layer 1/layer 2 inter-cell change or the layer 3 handover.

In a variant, the method may also include or the apparatus may be caused to perform: determining, by the distributed unit, that the layer 3 handover of the user equipment is not required, and transmitting, based on the decision, a message to inform the centralized unit that the layer 3 handover of the user equipment is not required, if said flag was received when a layer 3 handover of the user equipment is being executed.

In a variant, the receiving of the flag may pre-empt layer 1/layer 2 handover execution by the distributed unit.

In a variant, the method may also include or the apparatus may be caused to perform: triggering layer 1/layer 2 handover or multi-transmission/reception point operation to substitute or compliment the layer 3 handover.

In a variant, the message comprises a F1 application protocol message, where any communication between the distributed unit and the centralized unit of the network node may be considered an F1 application protocol message.

In a variant, the method may also include or the apparatus may be caused to perform: receiving an indication, at the distributed unit from the user equipment, when the user equipment sends a layer 3 measurement report to the centralized unit based on one or more measurement events.

In a variant, the indication may be based on the centralized unit or distributed unit configuration, and the indication comprises at least one of the layer 3 measurement results in a format comprehensible by the distributed unit or an indication of which of the measurement events were triggered.

In a variant, the method may also include or the apparatus may be caused to perform: based at least on the received indication and comparison with the received layer 1 measurement reports, determining whether a cell for which measurements are included in the layer 3 measurement report to the centralized unit, belongs to the distributed unit or not.

In a variant, the method may also include or the apparatus may be caused to perform: based at least on the received indication, determining, by the distributed unit, whether to trigger layer 1 or layer 3 cell change for the user equipment.

In a variant, when there is no cell belonging to the distributed unit that meets the criteria set for the one or more measurement events, the determining comprises determining not to issue a layer 1 cell change command to the user equipment.

In a variant, the method may also include or the apparatus may be caused to perform: when the centralized unit triggers an inter-distributed unit handover, receiving, from the centralized unit, an indication to pause layer 1/layer 2 inter-cell change, and responsive to receiving the indication to pause, stopping issuing of layer 1 handover commands towards the user equipment.

In a variant, the method may also include or the apparatus may be caused to perform: receiving an indication to resume the layer 1/layer 2 inter-cell change, and responsive to receiving the indication to resume, resuming issuing of layer 1 handover commands towards the user equipment.

In a variant, the method may also include or the apparatus may be caused to perform: seeking acknowledgement from the centralized unit before triggering, by the distributed unit, a layer 1/layer 2 handover command towards the user equipment, and triggering a layer 1/layer 2 handover command towards the user equipment only after the said acknowledgement is received from the centralized unit.

An embodiment may be directed to a method that may include transmitting, from a centralized unit of a network node, a message to a distributed unit of the network node, wherein the message comprises a flag to indicate that a layer 3 handover of a user equipment is being prepared or executed.

Another embodiment may be directed to an apparatus, which may include at least one processor and at least one memory comprising computer program code. The at least one memory and computer program code configured, with the at least one processor, to cause the apparatus at least to perform: transmitting, from a centralized unit, a message to a distributed unit, wherein the message comprises a flag to indicate that a layer 3 handover of a user equipment is being prepared or executed.

Another embodiment may be directed to an apparatus including means for transmitting, from a centralized unit, a message to a distributed unit, wherein the message comprises a flag to indicate that a layer 3 handover of a user equipment is being prepared or executed.

In a variant, the method may also include or the apparatus may be caused to perform: receiving an indication, from the distributed unit, to inform the centralized unit that the layer 3 handover of the user equipment is not required; and based on the indication, cancelling preparation of a target distributed unit or network node for the layer 3 handover of the user equipment.

In a variant, the transmitting of the flag may pre-empt layer 1/layer 2 handover execution by the distributed unit. In a variant, the message comprises a F1 application protocol message.

In a variant, the method may also include or the apparatus may be caused to perform: when the centralized unit triggers an inter-distributed unit handover, transmitting, to the distributed unit, an indication to pause layer 1/layer 2 inter-cell change.

In a variant, the method may also include or the apparatus may be caused to perform: transmitting an indication, to the distributed unit, to resume the layer 1/layer 2 inter-cell change.

In a variant, the method may also include or the apparatus may be caused to perform: receiving, by the centralized unit, a request for acknowledgement from the distributed unit before triggering, by the distributed unit, a layer 1/layer 2 handover command towards the user equipment; and sending, by the centralized unit, an acknowledgement to the distributed unit to trigger a layer 1/layer 2 handover, when a layer 3 handover is not initiated by the centralized unit.

### BRIEF DESCRIPTION OF THE DRAWINGS

For proper understanding of example embodiments, reference should be made to the accompanying drawings, wherein:

FIG. 1 illustrates an example system diagram depicting an example of L1/L2 centric inter-cell mobility scenarios;

FIG. 2 illustrates an example signaling diagram, according to certain embodiments;

FIG. 3 illustrates another example signaling diagram, according to certain embodiments;

FIG. 4A illustrates an example flow diagram of a method, according to one example embodiment;

FIG. 4B illustrates an example flow diagram of a method, according to one example embodiment;

FIG. 5 illustrates an example flow diagram of a method, according to an example embodiment;

FIG. 6A illustrates an example block diagram of an apparatus, according to an example embodiment;

FIG. 6B illustrates an example block diagram of an apparatus, according to an embodiment; and

FIG. 6C illustrates an example block diagram of an apparatus, according to an example embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for managing or controlling L1/L2 centric mobility and L3 mobility, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

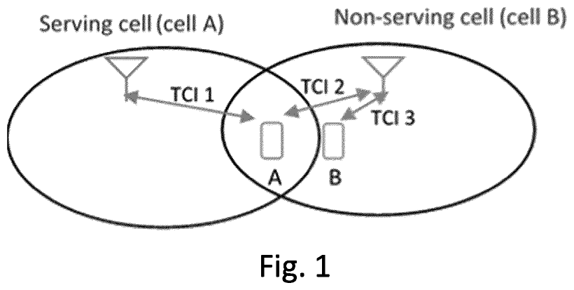

FIG. 1 illustrates an example system diagram depicting an example of L1/L2 centric inter-cell mobility scenarios. The example of FIG. 1 illustrates transmission control information (TCI) state exchange (e.g., TCI 1, TCI 2, TCI 3) between a serving cell (cell A) and a UE A, and between a non-serving cell (cell B) and UE A and UE B. Currently, for L1/L2 centric inter-cell mobility, the following two scenarios are being considered: 1. Inter-cell multiple transmit-receive point (multi-TRP)-like model (i.e., without serving cell change), and 2. Inter-cell handover (HO)-like model (i.e., with serving cell change).

For the inter-cell multi-TRP-like model scenario, a UE can receive, from serving cell, configuration of synchronization signal blocks (SSBs) of the transmit-receive point (TRP) with different physical cell identity (PCI) for beam measurement, and configurations needed to use radio resources for data transmission/reception including resources for different PCI. The UE may perform beam measurement for the TRP with different PCI and report it to a serving cell. Based on the above reports, TCI state(s) associated to the TRP with different PCI is activated from the serving cell (by L1/L2 signaling). The UE receives and transmits using UE-dedicated channel on TRP with different PCI. In this scenario, the UE should always be in coverage of a serving cell, also for multi-TRP case, e.g., UE should use common channels broadcast control channel (BCCH), paging channel (PCH) etc. from the serving cell.

For the L1/L2 mobility model (i.e., with serving cell change) scenario, a UE may receive, from serving cell, configuration of SSBs of the cell with different PCI for beam measurement/serving cell change. The UE performs beam measurement for the cell with different PCI and reports it to serving cell. The serving cell configuration for cell with other PCI is provided to the UE by radio resource control (RRC) (pre-configuration for serving cell change). Based on the above reports, TCI states for cell with different PCI is activated along with the serving cell change (by L1/L2 signaling). The UE may change the serving cell and start receiving/transmitting using the pre-configured UE-dedicated channel and TCI states.

Certain example embodiments discussed herein provide systems and methods that allow a network to manage and/or control L1/L2 centric mobility (beam level mobility with medium access control (MAC)-layer at distributed unit (DU)-gNB) and L3 mobility (cell level mobility with RRC-layer at central unit (CU)-gNB), e.g., by enabling coordination between DU-gNB (responsible for L1/L2 centric mobility) and CU-gNB (responsible for L3 mobility) in inter-DU mobility. This coordination may be achieved by ensuring that when a message concerning L3 mobility is sent to the CU, the DU can be made aware of this either by the CU-gNB or the UE.

The automatic neighbour relation (ANR) awareness in an NG-RAN node is limited to the central unit-control plane (CU-CP). Thus, the neighbour relations of a cell/distributed unit (DU) is known only at the CU-CP.

The gNB-DU only knows the PCI/NR-cell global identifier (CGI) of its own cells. It is neither aware of a cell in a neighbouring DU, nor can it uniquely identify a cell in the neighbouring DU/gNB even if a PCI is reported to it (i.e., it has no direct association with the other DU and there is no inter-DU interface currently defined).

L1/L2 centric inter-cell mobility is expected to work as follows. The CU-CP configures one or more cells of the same DU for L1/L2 centric inter-cell mobility through RRC configuration. This cell information and its configuration may be decided by DU (and conveyed to CU) or CU may also ask the DU for the configuration pertaining to some cells (based on the L3 measurements), and is then configured to UE by CU. The CU-CP also configures the UE for both L1 RSRP and L3 measurements. L3 measurements may be sent over RRC protocol to the CU-CP. This is used for inter-DU mobility and are normally not conveyed to DU. L1 RSRP measurements may be sent over L1/MAC protocol to the DU. This is used for intra-DU mobility (currently, per Release-16, CU is not aware of the L1 measurements as the beam management is only done at DU level). DU evaluates the L1 measurement results (e.g. L1-RSRP, L1-RSRQ, indication from UE that event is triggered without any L1 measurement results) and orders the UE to perform intra-DU mobility (when the HO criteria is met) using a L2 MAC control element (CE) command. The CU-CP evaluates the L3 measurements and may perform an inter-DU mobility event (after HO criteria is met and HO preparation is done) using a L2 RRC reconfiguration (HO command) message.

The UE may have measured an inter-DU cell and the measurement events (e.g., A3/A5) may have been satisfied, and the UE may have sent a L3 measurement report to the CU-CP. This awareness is not available at the DU since the RRC measurement reports cannot be deciphered at the DU. The UE may also send in parallel the L1-reference signal received power (RSRP) measurement reports to the DU, which may be event based or even periodic.

Since there is no awareness of the L3 measurements at the DU, it may perform intra-DU cell change to the best cell of that DU and this may collide with and L3 HO command. As an example, assume UE is at serving cell A, UE has an intra-DU neighbour cells B and C, UE has an inter-DU neighbour cell D, and DU programs L1 HO trigger to intra-DU cell B. The CU monitors L3 measurements for cell B, cell C and cell D. The CU would know cell B and C are intra-DU cells and, if DU triggers a L1 HO to Cell B, the CU can avoid triggering a HO to cell C. Eventually, DU may trigger a HO to cell C. The CU monitors L3 measurements for cell D only. The CU would not know when DU will trigger L1 HO to cell B (lack of awareness of L1 measurements), so it cannot avoid triggering a simultaneous HO to cell D. In case of a simultaneous HO, the UE may have two HO commands at the same time or one followed by the other, and the UE may not know how to deal with this situation.

This collision not only creates ping pong and confusion for the UE, but also could prevent the UE from moving to the best cell, and even lead to radio link failure (RLF). Resolution of such a collision could be left to UE implementation, but this will result in unexpected behaviour in the field and may result in RLFs if not handled properly.

In view of the above, a problem may arise in which, even though L3 HO command for an inter-DU target cell goes through a DU, the DU is agnostic to the contents of this message and therefore cannot co-ordinate with its own triggered L1 HO. Example embodiments can address at least this problem, as well as other possible problems not explicitly discussed herein.

As will be discussed in detail below, some example embodiments may provide several alternatives for implementation of the methods described herein for managing or controlling L1/L2 centric mobility and L3 mobility. For example, in an embodiment, a CU-gNB may include a flag for L3 HO to the DU-gNB. According to a further embodiment, the UE may indicate the DU-gNB of L3 measurement report. In some embodiments, the control for L1/L2 HO may be paused/resumed from CU-gNB to DU-gNB. According to an embodiment, the UE might always prioritize L3 HO. In some embodiments, the DU-gNB may seek approval from the CU-gNB before a L1/L2 HO. It is noted that these alternatives may be implemented separately or combined, according to certain embodiments.

As introduced above, example embodiments provide for interworking of L3 mobility and L1/L2 centric inter-cell change, for instance, at least to prevent confusion at the UE. For example, in certain embodiments, L3 messages (in UL and/or DL) related to mobility are “tagged” so that both DU become aware of them.

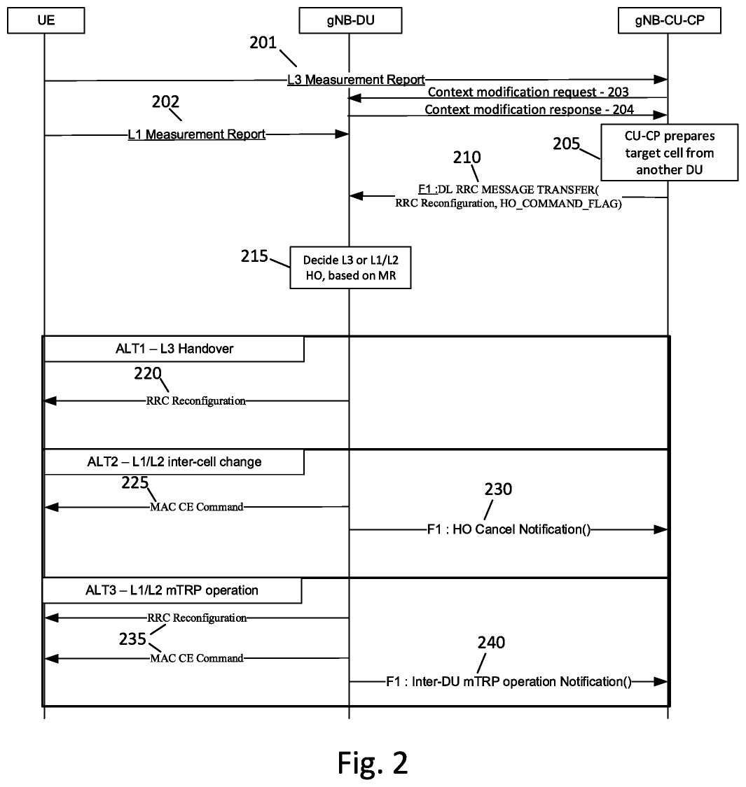

FIG. 2 illustrates an example signaling diagram for interworking between L3 and L1 HO, according to some example embodiments. As illustrated in the example of FIG. 2, the signaling may involve a UE, gNB-DU, and gNB-CU-CP. At 201, the UE may transmit, and the gNB-CU-CP may receive, a L3 measurement report. In the example of FIG. 2, at 202, the UE may transmit, and the gNB-DU may receive, a L1 measurement report. As illustrated at 205, the gNB-CU-CP may prepare a target cell from another DU. The gNB-CU-CP may transmit, at 210, a L3 HO command. In an embodiment, when the CU-CP sends a HO command message, the command may include a flag (HO_COMMAND_FLAG) in the F1 application protocol (AP) message to indicate that the RRC message is a L3 HO. The inclusion of the flag may allow the DU to pre-empt L1/L2 HO attempts when L3 HO is being prepared and/or executed in anticipation of this. For example, since the DU does not know about L3 HO reports, the CU can inform the DU, e.g., via F1 AP, that L3 HO is being prepared so the DU can act accordingly. As one example, at 203, the CU-CP may indicate in a F1: UE context modification request sent to the DU to pause data transmission while the inter-DU HO is being prepared. According to this example, at 204, the DU may transmit and the CU-CP may receive a F1: UE context modification response. In an embodiment, the context modification request may also be used to indicate inter-DU HO. According to some example embodiments, the inclusion of the flag (e.g., HO_COMMAND_FLAG) at 210 can allow the DU to decide to pre-empt or not pre-empt L1/L2 HO attempts when L3 HO is being prepared and/or executed, e.g., depending on the DU configuration or based upon another indication that may be provided in the message.

It is noted that the F1 interface may provide means for interconnecting a gNB-CU and gNB-DU of a gNB within a NG-RAN or for interconnecting a gNB-CU and gNB-DU of an en-gNB within a E-UTRAN. The F1 AP can support functions of the F1 interface by providing certain signaling procedures. Although some example embodiments described herein may refer to the F1 interface or F1 AP message(s), example embodiments are not limited to just F1 or F1 AP implementations. For instance, certain embodiments can be applicable to any interface or connection between a CU and DU or similar units of a gNB or network node. Further, according to certain embodiments, an F1 AP message may refer to any communication between a DU and CU or vice versa.

In an embodiment, as illustrated in the example of FIG. 2 at 215, the DU can use this information received at 210 to decide whether the UE should perform a L1/L2 inter-cell change or a L3 HO (i.e., the DU can act based on the L3 HO command). In an embodiment, when the DU determines that L3 HO should be performed, the DU may trigger L3 HO by transmitting a RRC reconfiguration message to the UE at 220 (ALT1-L3 Handover in FIG. 2). In other words, when the DU decides that there is no reason to pre-empt the L3 HO, then the DU may transmit the RRC reconfiguration message to the UE at 220. In another embodiment, when the DU determines that L1/L2 inter-cell change should be performed, the DU may trigger L1/L2 inter-cell change by transmitting a MAC CE to the UE at 225 (ALT2-L1/L2 inter-cell change in FIG. 2).

In case the DU determines that the L3 HO command is not needed (e.g., when for an intra-DU cell has been reported to have L1 RSRP >a predefined threshold) it may send a notification, at 230 or 240, to the CU-CP (via a new F1AP message) to inform about the same. The CU-CP may use the notification to cancel the target DU preparation. Alternatively, the DU can also trigger mTRP operation, at 235, to ensure better performance for the L3 HO command (ALT3-L1/L2 mTRP operation in FIG. 2).

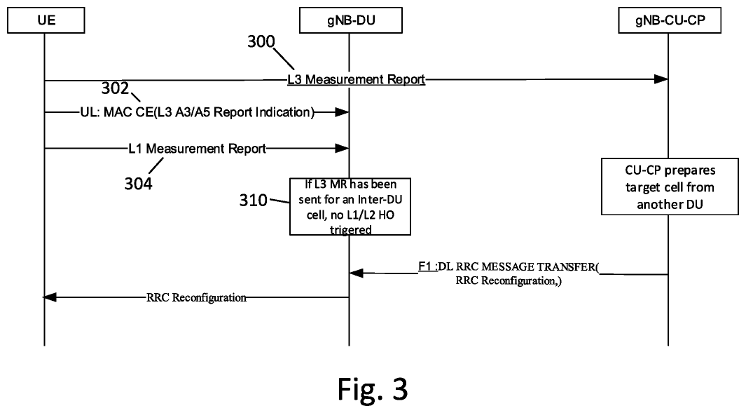

FIG. 3 illustrates another example signaling diagram for interworking between L3 and L1 HO, according to certain example embodiments. As illustrated in the example of FIG. 3, the signaling may involve a UE, gNB-DU, and gNB-CU-CP. In the example of FIG. 3, at 300, the UE may transmit, and the gNB-DU may receive, a L3 measurement report. According to an embodiment, at 302, the UE may indicate to the gNB-DU, e.g., via a MAC CE in UL, when an L3 measurement report is sent to the gNB-CU-CP based on events. For example, the UE may indicate the L3 measurement report is based on measurement events, such as event A3 or event A5. In certain embodiments, this indication by the UE, at 302, can be based on CU or DU configuration and may be either duplication of the L3 measurement results in a format compatible with DU or just an indication of which event was triggered. In one embodiment, the UE may transmit, at 304, a L1 measurement report to the gNB-DU.

According to certain embodiments, based at least on the indication received at 302, the DU can determine if the measured cell that has been reported for a measurement event, such as event A3 and/or event A5, belongs to the same DU or not. According to some embodiments, depending on the indication received at 302, the DU may decide to delay, pause or hasten L1/L2 mobility procedure trigger. For example, in an embodiment, if there is no cell meeting the measurement event criteria (e.g., A3/A5 criteria based on L1 RSRP reports), the DU may delay or not issue a L1 cell change via MAC CE and no L1/L2 HO is triggered, as shown at 310.

It is noted that, although some example embodiments described herein may refer to the MAC CE message(s), example embodiments are not limited to just MAC CE implementations. For instance, certain embodiments can be applicable to any interface or connection between a UE and CU or similar units of a UE and gNB or network node. Further, according to certain embodiments, a MAC CE message may refer to any communication between a UE and DU or vice versa.

According to a further example embodiment, when the gNB-CU-CP triggers an inter-DU HO, the gNB-CU-CP may indicate to the UE's source DU, e.g., using a new F1 message, to pause L1/L2 centric inter-cell change until a resume L1/L2 centric inter-cell change command is sent. Upon receiving the new pause message, the source DU may stop issuing L1 HO commands. Then, upon receiving the new resume message, the source DU may resume issuing L1 HO commands.

According to a further example embodiment, when the gNB-CU-CP triggers an inter-DU HO, the gNB-CU-CP may indicate to the UE's source DU, e.g., using a new F1 or any similar kind of message, to pause L1/L2 centric inter-cell change until a resume L1/L2 centric inter-cell change command is sent. Upon receiving the new pause message, the source DU may stop issuing L1 HO commands. Then, upon receiving the new resume message, the source DU may resume issuing L1 HO commands.

In yet a further example embodiment, the UE can be configured to prioritize a L3 HO command over a L2 MAC CE command for any cell change and the DU will not process L1/L2 HO commands when the L3 HO is being prepared or executed.

According to a further embodiment, the DU may seek acknowledgement from CU-CP before triggering a L1/L2 HO command towards the UE. As an example, this may be implemented using a DU initiated F1 procedure with the CU.

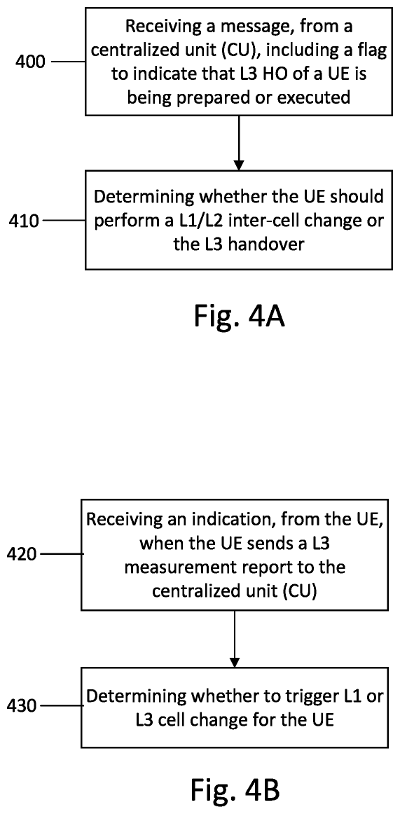

FIG. 4A illustrates an example flow diagram of a method for managing or controlling layer 1 (L1)/layer 2 (L2) centric mobility and layer 3 (L3) mobility, according to an example embodiment. In certain example embodiments, the flow diagram of FIG. 4A may be performed by a network entity or network node in a communications system, such as LTE or 5G NR. In some example embodiments, the network entity performing the method of FIG. 4A may include or be included in a base station, access node, node B, eNB, gNB, NG-RAN node, transmission-reception points (TRPs), high altitude platform stations (HAPS), relay station or the like. In one embodiment, the network node performing the method of FIG. 4A may include a DU of a network node, gNB, or cell, such as one or more of the gNB-DUs illustrated in the example of FIG. 2 or FIG. 3, or similar radio node. Therefore, the method of FIG. 4A may include one or more operations illustrated in the examples of FIG. 2 or FIG. 3.

As illustrated in the example of FIG. 4A, the method may include, at 400, receiving, at a distributed unit (DU) of a network node, a message from a centralized unit (CU) of the network node. For example, the message may include a F1 application protocol (AP) message. In an embodiment, the message may include a flag to indicate that a layer 3 (L3) handover of a user equipment (UE) is being prepared or executed. For instance, the receiving 400 may include receiving a RRC reconfiguration message including a L3 HO command over F1 AP with the flag to indicate that the L3 HO is being prepared or executed. In one embodiment, the receiving of the message including the flag may pre-empt layer 1 (L1)/layer 2 (L2) handover attempts by the distributed unit (DU). According to an embodiment, based on at least one of the received message and a measurement report received from the user equipment (UE), the method may include, at 410, determining whether the user equipment (UE) should perform a layer 1 (L1)/layer 2 (L2) inter-cell change or the layer 3 (L3) handover.

In some embodiments, the method may include determining, by the distributed unit (DU), that the layer 3 (L3) handover of the user equipment (UE) is not required. For instance, in one embodiment, the distributed unit (DU) may determine that layer 3 (L3) handover of the user equipment (UE) is not required when L1 RSRP measurements of a cell is greater than a predefined threshold. In this case, the method may include transmitting an indication to inform the centralized unit (CU) that the layer 3 (L3) handover of the user equipment (UE) is not required. According to certain embodiments, the method may include triggering layer 1 (L1)/layer 2 (L2) handover or multi-transmission/reception point (mTRP) operation to substitute or compliment the layer 3 (L3) handover of the user equipment (UE).

According to certain embodiments, when the centralized unit (CU) triggers an inter-distributed unit (DU) handover, the method may include receiving, from the centralized unit (CU), an indication to pause layer 1 (L1)/layer 2 (L2) inter-cell change. Responsive to receiving the indication to pause, the method may include stopping issuing of layer 1 (L1) handover commands towards the user equipment (UE). The method may further include receiving an indication to resume the layer 1 (L1)/layer 2 (L2) inter-cell change and, responsive to receiving the indication to resume, resuming issuing of layer 1 (L1) handover commands towards the user equipment (UE).

In one embodiment, the method may include avoiding or preventing, by the distributed unit (DU), processing of L1/L2 HO commands when a L3 HO command is being prepared or executed.

According to one embodiment, the method may also include seeking acknowledgement from the centralized unit (CU) before triggering, by the distributed unit (DU), a layer 1 (L1)/layer 2 (L2) handover command towards the user equipment (UE).

FIG. 4B illustrates an example flow diagram of a method for managing or controlling layer 1 (L1)/layer 2 (L2) centric mobility and layer 3 (L3) mobility, according to an example embodiment. In certain example embodiments, the flow diagram of FIG. 4B may be performed by a network entity or network node in a communications system, such as LTE or 5G NR. In some example embodiments, the network entity performing the method of FIG. 4B may include or be included in a base station, access node, node B, eNB, gNB, NG-RAN node, transmission-reception points (TRPs), high altitude platform stations (HAPS), relay station or the like. In one embodiment, the network node performing the method of FIG. 4B may include a DU of a network node, gNB, or cell, such as one or more of the gNB-DUs illustrated in the example of FIG. 2 or FIG. 3, or similar radio node. Therefore, the method of FIG. 4B may include one or more operations illustrated in the examples of FIG. 2 or FIG. 3.

As illustrated in the example of FIG. 4B, the method may include, at 420, receiving an indication, at the distributed unit (DU) from the user equipment (UE), when the user equipment (UE) sends a layer 3 (L3) measurement report to the centralized unit (CU) based on one or more measurement events, such as A3 or A5 measurement events. In one embodiment, the indication received at 420 may be based on the centralized unit (CU) or distributed unit (DU) configuration, and/or the indication may include at least one of the layer 3 (L3) measurement results or an indication of which of the measurement events (e.g., A3 or A5) were triggered. In an embodiment, based at least on the received indication, the method may include, at 430, determining, by the distributed unit (DU), whether to trigger layer 1 (L1) or layer 3 (L3) cell change for the user equipment (UE). According to one embodiment, the determining 430 may include determining whether a cell for which measurements are included in the layer 3 (L3) measurement report, i.e., a measured cell that is reported for A3/A5 events, belongs to the distributed unit (DU) or not. In an embodiment, when there is no cell meeting the criteria for the one or more measurement events (e.g., meeting the A3/A5 criteria based on L1 RSRP reports), the determining may include determining not to issue a layer 1 (L1) cell change to the user equipment (UE).

It should be noted that, according to some example embodiments, the procedures illustrated in the examples of FIGS. 4A and 4B may be combined. For instance, if combined, the method may first include receiving the indication, as shown at 420 of FIG. 4B, when the user equipment (UE) sends the layer 3 (L3) measurement report to the centralized unit (CU) and determining, at 430, whether to trigger layer 1 (L1) or layer 3 (L3) cell change for the user equipment (UE). In this example, the method may then include receiving, as shown at 400 of FIG. 4A, the message from the centralized unit (CU) and determining, at 420, whether the user equipment (UE) should perform a layer 1 (L1)/layer 2 (L2) inter-cell change or the layer 3 (L3) handover.

FIGS. 4A and 4B are provided as two examples of a method, according to certain embodiments. Other examples are possible as one or more procedures discussed above or illustrated in FIG. 4A or 4B may be skipped or may be performed in a different order, or additional procedures may be added.

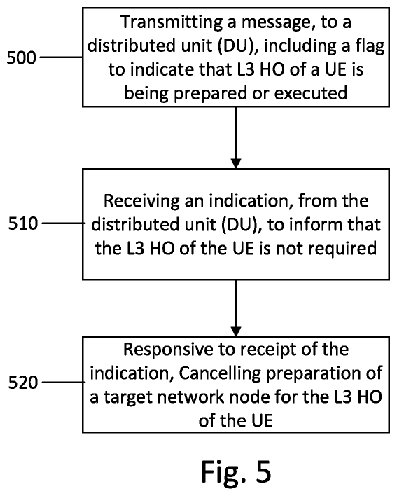

FIG. 5 illustrates an example flow diagram of a method for managing or controlling layer 1 (L1)/layer 2 (L2) centric mobility and layer 3 (L3) mobility, according to an example embodiment. In certain example embodiments, the flow diagram of FIG. 5 may be performed by a network entity or network node in a communications system, such as LTE or 5G NR. In some example embodiments, the network entity performing the method of FIG. 5 may include or be included in a base station, access node, node B, eNB, gNB, NG-RAN node, transmission-reception points (TRPs), high altitude platform stations (HAPS), relay station or the like. In one embodiment, the network node performing the method of FIG. 5 may include a CU or CU-CP of a network node, gNB, or cell, such as one or more of the gNB-CU-CPs illustrated in the example of FIG. 2 or FIG. 3, or similar radio node. Therefore, the method of FIG. 5 may include one or more operations illustrated in the examples of FIG. 2 or FIG. 3.

As illustrated in the example of FIG. 5, the method may include, at 500, transmitting, from a centralized unit (CU) of a network node, a message to a distributed unit (DU) of the network node. In an embodiment, the message may include a flag to indicate that a layer 3 (L3) handover of a user equipment (UE) is being prepared or executed. The message may include, for example, the message comprises a F1 AP message. According to certain embodiments, the transmitting 500 of the message including the flag may pre-empt layer 1 (L1)/layer 2 (L2) handover attempts by the distributed unit (DU).

In some embodiments, the method may optionally include, at 510, receiving an indication, from the distributed unit (DU), to inform the centralized unit (CU) that the layer 3 (L3) handover of the user equipment (UE) is not required. For instance, in one embodiment, the distributed unit (DU) may decide that layer 3 (L3) handover of the user equipment (UE) is not required if UE reported L1 RSRP measurements of a cell is greater than a predefined threshold. Based on receipt of the indication, the method may include, at 520, cancelling preparation of a target network node for the layer 3 (L3) handover of the user equipment (UE).

According to certain embodiments, the method may include triggering, by the centralized unit (CU), an inter-DU handover and, when the centralized unit (CU) triggers an inter-distributed unit (DU) handover, transmitting, to the distributed unit (DU), an indication to pause layer 1 (L1)/layer 2 (L2) inter-cell change. In one embodiment, the method may include later transmitting an indication, to the distributed unit (DU), to resume the layer 1 (L1)/layer 2 (L2) inter-cell change.

In some embodiments, the method may include receiving, by the centralized unit (CU), a request for acknowledgement from the distributed unit (DU) before triggering, by the distributed unit (DU), a layer 1 (L1)/layer 2 (L2) handover command towards the user equipment (UE).

It is noted that FIG. 5 is provided as one example of a method, according to certain embodiments. Other examples are possible as one or more procedures discussed above or illustrated in FIG. 5 may be skipped or may be performed in a different order.

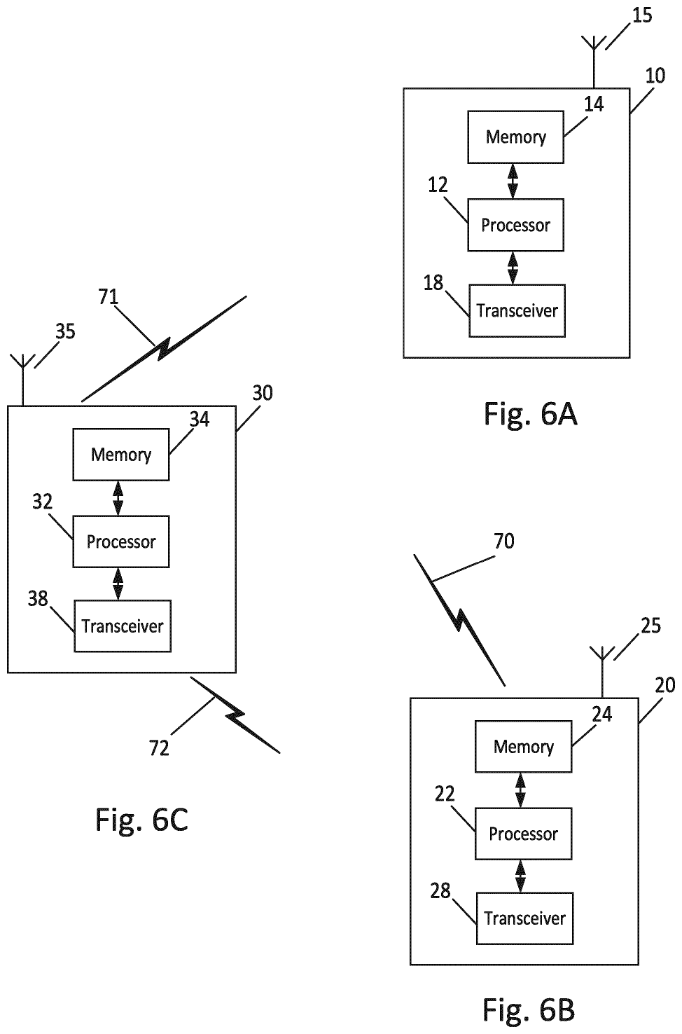

FIG. 6A illustrates an example of an apparatus 10 according to an embodiment. In an embodiment, apparatus 10 may be a node, host, or server in a communications network or serving such a network. For example, apparatus 10 may be a satellite, base station, a Node B, an evolved Node B (eNB), 5G Node B or access point, next generation Node B (NG-NB or gNB), WLAN access point, TRP, IAB node, and/or HAPS, associated with a radio access network, such as a LTE network, 5G or NR. In example embodiments, apparatus 10 may be NG-RAN node, an eNB in LTE, or gNB in 5G. According to one embodiment, apparatus 10 may be or may include a network node, gNB, or cell, for example.

It should be understood that, in some example embodiments, apparatus 10 may be comprised of an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 6A.

As illustrated in the example of FIG. 6A, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 6A, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device).

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry or control circuitry. In addition, in some embodiments, transceiver 18 may be included in or may form a part of transceiver circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to case an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be a NW node or RAN node, such as a base station, access point, Node B, eNB, gNB, WLAN access point, or the like. In one embodiment, apparatus 10 may be a DU of a network node or gNB-DU, or the like. For example, in some embodiments, apparatus 10 may be configured to perform one or more of the processes depicted in any of the flow charts or signaling diagrams described herein, such as those illustrated in FIGS. 2-5. In some embodiments, as discussed herein, apparatus 10 may be configured to perform a procedure relating to managing or controlling layer 1 (L1)/layer 2 (L2) centric mobility and layer 3 (L3) mobility, as described elsewhere herein, for instance.

FIG. 6B illustrates an example of an apparatus 20 according to another embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like. It should be noted that one of ordinary skill in the art would understand that apparatus 20 may include components or features not shown in FIG. 6B.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 6B.

As illustrated in the example of FIG. 6B, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 6B, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 or apparatus 30 via a wireless or wired communications link or interface 70 according to any radio access technology, such as NR.

According to some embodiments, processor 22 and memory 24 may be included in or may form a part of processing circuitry/means or control circuitry/means. In addition, in some embodiments, transceiver 28 may be included in or may form a part of transceiving circuitry or transceiving means.

As discussed above, according to some embodiments, apparatus 20 may be a UE, communication node, mobile equipment (ME), mobile station, mobile device, stationary device, IoT device, for example. According to certain embodiments, apparatus 20 may be controlled by memory 24 and processor 22 to perform the functions associated with example embodiments described herein. For example, in some embodiments, apparatus 20 may be configured to perform one or more of the processes depicted in any of the flow charts or signaling diagrams described herein, such as that illustrated in FIGS. 2-5. Thus, according to an embodiment, apparatus 20 may be configured to perform a procedure relating to managing or controlling layer 1 (L1)/layer 2 (L2) centric mobility and layer 3 (L3) mobility, as discussed elsewhere herein, for instance.

For example, in one embodiment, apparatus 20 may be controlled to prioritize a L3 HO command over a L2 MAC CE command for any cell change.

FIG. 6C illustrates an example of an apparatus 30 according to another example embodiment. In an example embodiment, apparatus 30 may be a node or element in a communications network or associated with such a network, such as a satellite, base station, a Node B, an evolved Node B (eNB), 5G Node B or access point, next generation Node B (NG-NB or gNB), and/or WLAN access point, associated with a radio access network, such as a LTE network, 5G or NR. According to one embodiment, apparatus 30 may be or may be included in a CU or CU-CP of a network node, gNB, or cell, for example.

In some example embodiments, apparatus 30 may include one or more processors, one or more computer-readable storage medium (for example, memory, storage, or the like), one or more radio access components (for example, a modem, a transceiver, or the like), and/or a user interface. In some example embodiments, apparatus 30 may be configured to operate using one or more radio access technologies, such as GSM, LTE, LTE-A, NR, 5G, WLAN, WiFi, NB-IoT, MulteFire, and/or any other radio access technologies. It should be noted that one of ordinary skill in the art would understand that apparatus 30 may include components or features not shown in FIG. 6C.

As illustrated in the example of FIG. 6C, apparatus 30 may include or be coupled to a processor 32 for processing information and executing instructions or operations. Processor 32 may be any type of general or specific purpose processor. In fact, processor 32 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 32 is shown in FIG. 6C, multiple processors may be utilized according to other example embodiments. For example, it should be understood that, in certain example embodiments, apparatus 30 may include two or more processors that may form a multiprocessor system (e.g., in this case processor 32 may represent a multiprocessor) that may support multiprocessing. In certain example embodiments, the multiprocessor system may be tightly coupled or loosely coupled (e.g., to form a computer cluster).

Processor 32 may perform functions associated with the operation of apparatus 30 including, as some examples, precoding of antenna gain/phase parameters, encoding and decoding of individual bits forming a communication message, formatting of information, and overall control of the apparatus 30, including processes related to management of communication resources.

Apparatus 30 may further include or be coupled to a memory 34 (internal or external), which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 34 can be comprised of any combination of random access memory (RAM), read only memory (ROM), static storage such as a magnetic or optical disk, hard disk drive (HDD), or any other type of non-transitory machine or computer readable media. The instructions stored in memory 34 may include program instructions or computer program code that, when executed by processor 32, enable the apparatus 30 to perform tasks as described herein.

In an example embodiment, apparatus 30 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 32 and/or apparatus 30.

In some example embodiments, apparatus 30 may also include or be coupled to one or more antennas 35 for receiving a downlink signal and for transmitting via an uplink from apparatus 30. Apparatus 30 may further include a transceiver 38 configured to transmit and receive information. The transceiver 38 may also include a radio interface (e.g., a modem) coupled to the antenna 35. The radio interface may correspond to a plurality of radio access technologies including one or more of GSM, LTE, LTE-A, 5G, NR, WLAN, NB-IoT, BT-LE, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 38 may be configured to modulate information on to a carrier waveform for transmission by the antenna(s) 35 and demodulate information received via the antenna(s) 35 for further processing by other elements of apparatus 30. In other example embodiments, transceiver 38 may be capable of transmitting and receiving signals or data directly. Additionally or alternatively, in some example embodiments, apparatus 30 may include an input and/or output device (I/O device). In certain example embodiments, apparatus 30 may further include a user interface, such as a graphical user interface or touchscreen.

In an example embodiment, memory 34 stores software modules that provide functionality when executed by processor 32. The modules may include, for example, an operating system that provides operating system functionality for apparatus 30. The memory may also store one or more functional modules, such as an application or program, to provide additional functionality for apparatus 30. The components of apparatus 30 may be implemented in hardware, or as any suitable combination of hardware and software. According to an example embodiment, apparatus 30 may optionally be configured to communicate with apparatus 10 via a wireless or wired communications link 71 and/or to communicate with apparatus 20 via a wireless or wired communications link 72, according to any radio access technology, such as NR.

According to some example embodiments, processor 32 and memory 34 may be included in or may form a part of processing circuitry or control circuitry. In addition, in some example embodiments, transceiver 38 may be included in or may form a part of transceiving circuitry.

As discussed above, according to some example embodiments, apparatus 30 may be or may be included in a CU or CU-CP of a network node, gNB, or cell, for example. According to certain example embodiments, apparatus 30 may be controlled by memory 34 and processor 32 to perform the functions associated with example embodiments described herein. For instance, in some example embodiments, apparatus 30 may be configured to perform one or more of the processes depicted in any of the diagrams or signaling flow diagrams described herein, such as those illustrated in FIGS. 2-5. According to certain example embodiments, apparatus 30 may be configured to perform a procedure relating to managing or controlling layer 1 (L1)/layer 2 (L2) centric mobility and layer 3 (L3) mobility, as described elsewhere herein, for instance.

In some embodiments, an apparatus (e.g., apparatus 10 and/or apparatus 20 and/or apparatus 30) may include means for performing a method, a process, or any of the variants discussed herein. Examples of the means may include one or more processors, memory, controllers, transmitters, receivers, and/or computer program code for causing the performance of the operations.

In view of the foregoing, certain example embodiments provide several technological improvements, enhancements, and/or advantages over existing technological processes and constitute an improvement at least to the technological field of wireless network control and/or management. For example, as discussed in detail above, certain embodiments provide ways to manage and/or control L1/L2 centric mobility and L3 mobility. Some benefits or advantages may include that example embodiments can prevent a CU and DU from sending a UE two HO commands at the same time for different target cells. Therefore, certain embodiments may enhance the HO procedures (CU and DU coordination of triggering the handover using L1 or L3 mobility mechanisms) by avoiding multiple HOs that may not be necessary.

Accordingly, the use of certain example embodiments results in improved functioning of communications networks and their nodes, such as base stations, eNBs, gNBs, and/or IoT devices, UEs or mobile stations.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

1-61. (canceled)

62. An apparatus, comprising:
at least one processor; and
at least one memory comprising computer program code,
the at least one memory and computer program code configured, with the at least one processor, to cause the apparatus at least to:
receive, at distributed unit, a message from a centralized unit, wherein the message comprises a flag to indicate that a layer 3 handover of a user equipment is being prepared or executed;
based on at least one of the said received message and a measurement report received from the user equipment, determine, by the distributed unit, whether the user equipment should perform a layer 1/layer 2 inter-cell change or the layer 3 handover.

63. The apparatus of claim 62, further caused to:
determine, by the distributed unit, that the layer 3 handover of the user equipment is not required; and
transmit a message to inform the centralized unit that the layer 3 handover of the user equipment is not required.

64. The apparatus of claim 62, wherein the receiving of the flag may pre-empt layer 1/layer 2 handover execution by the distributed unit.

65. The apparatus of claim 62, wherein the at least one memory and computer program code are configured, with the at least one processor, to cause the apparatus at least to:
trigger layer 1/layer 2 handover or multi-transmission/reception point operation to substitute or compliment the layer 3 handover.

66. The apparatus of claim 62, wherein the message comprises a F1 application protocol message, wherein any communication between the distributed unit and the centralized unit of the network node is considered an F1 application protocol message.

67. The apparatus of claim 62, wherein the at least one memory and computer program code are configured, with the at least one processor, to cause the apparatus at least to:
receive an indication, at the distributed unit from the user equipment, when the user equipment sends a layer 3 measurement report to the centralized unit based on one or more measurement events.

68. The apparatus of claim 67, wherein the indication is based on the centralized unit or distributed unit configuration, and wherein the indication comprises at least one of the layer 3 measurement results in a format comprehensible by the distributed unit or an indication of which of the measurement events were triggered.

69. The apparatus of claim 67, wherein the at least one memory and computer program code are configured, with the at least one processor, to cause the apparatus at least to:
based at least on the received indication and comparison with the received layer 1 measurement reports, determine whether a cell for which measurements are included in the layer 3 measurement report to the centralized unit, belongs to the distributed unit or not.

70. The apparatus of claim 67, wherein the at least one memory and computer program code are configured, with the at least one processor, to cause the apparatus at least to:
based at least on the received indication, determine, by the distributed unit, whether to trigger layer 1 or layer 3 cell change for the user equipment.

71. The apparatus of claim 69, wherein, when there is no cell belonging to the distributed unit that meet the criteria set for the one or more measurement events, the determining comprises determining not to issue a layer 1 cell change command to the user equipment.

72. The apparatus of claim 62, wherein the at least one memory and computer program code are configured, with the at least one processor, to cause the apparatus at least to:
when the centralized unit triggers an inter-distributed unit handover, receive, from the centralized unit, an indication to pause layer 1/layer 2 inter-cell change; and
responsive to receiving the indication to pause, stop issuing of layer 1 handover commands towards the user equipment.

73. The apparatus of claim 72, wherein the at least one memory and computer program code are configured, with the at least one processor, to cause the apparatus at least to:
receive an indication to resume the layer 1/layer 2 inter-cell change; and
responsive to receiving the indication to resume, resume issuing of layer 1 handover commands towards the user equipment.

74. The apparatus of claim 62, wherein the at least one memory and computer program code are configured, with the at least one processor, to cause the apparatus at least to:
seek acknowledgement from the centralized unit before triggering, by the distributed unit, a layer 1/layer 2 handover command towards the user equipment; and
trigger a layer 1/layer 2 handover command towards the user equipment only after the said acknowledgement is received from the centralized unit.

75. An apparatus, comprising:
at least one processor; and
at least one memory comprising computer program code,
the at least one memory and computer program code configured, with the at least one processor, to cause the apparatus at least to:
transmit, from a centralized unit, a message to a distributed unit, wherein the message comprises a flag to indicate that a layer 3 handover of a user equipment is being prepared or executed.

76. The apparatus of claim 75, wherein the at least one memory and computer program code are configured, with the at least one processor, to cause the apparatus at least to:
receive an indication, from the distributed unit, to inform the centralized unit that the layer 3 handover of the user equipment is not required; and
based on the indication, cancel preparation of a target distributed unit or network node for the layer 3 handover of the user equipment.

77. The apparatus of claim 75, wherein the transmitting of the flag may pre-empt layer 1/layer 2 handover execution by the distributed unit.

78. The apparatus of claim 75, wherein the message comprises a F1 application protocol message.

79. The apparatus of claim 75, wherein the at least one memory and computer program code are configured, with the at least one processor, to cause the apparatus at least to:
when the centralized unit triggers an inter-distributed unit (DU) handover, transmit, to the distributed unit, an indication to pause layer 1/layer 2 inter-cell change.

80. The apparatus of claim 79, wherein the at least one memory and computer program code are configured, with the at least one processor, to cause the apparatus at least to:
transmit an indication, to the distributed unit, to resume the layer 1/layer 2 inter-cell change.

81. The apparatus of claim 79, wherein the at least one memory and computer program code are configured, with the at least one processor, to cause the apparatus at least to:
receive, by the centralized unit, a request for acknowledgement from the distributed unit before triggering, by the distributed unit, a layer 1/layer 2 handover command towards the user equipment; and
send, by the centralized unit, an acknowledgement to the distributed unit to trigger a layer 1/layer 2 handover, when a layer 3 handover is not initiated by the centralized unit.
